(19) United States
(12) Patent Application Publication
(10) Pub. No.: US 2002/0188608 A1
(43) Pub. Date: Dec. 12, 2002

(54) Automated license dependency resolution and license generation

(76) Inventors: Dean S. Nelson, Meridian, ID (US); James Clough, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/880,321

(22) Filed: Jun. 12, 2001

(51) Int. Cl. G06F 9/44; G06F 17/30

(52) U.S. Cl. 707/10

(57) ABSTRACT

A computing system is configured to identify product attributes, including components, associated with a product and to resolve the attributes to determine licensing dependencies for the product. In another embodiment, the licensing dependencies are resolved with other product attributes to identify a potential license for the product.

### BACKGROUND OF THE INVENTION

Conventional software development efforts typically occur in what may be categorized, generally, as self-contained or “silo” environments (models). Using a self-contained model, a company develops a software product, or may contract to have the product developed, under strict control requirements and with a full understanding of the originating source of the development (i.e., who the developer is) and of resources used in the development (i.e., development tools, libraries, other code, etc.). In this context, any intellectual property rights associated with the development, and any rights and restrictions associated with resources used, are known at the outset. For example, rights associated with source code that is newly developed, whether internally or under contract, are easily identified. Additionally, rights and restrictions associated with any libraries or other resources that may be used in the development are also easily identified.

In recent years, software development efforts have increasingly occurred in what may be categorized, generally, as collaborative development environments. The collaborative development model generally employs a more open, cooperative development standard among parties or communities than the self-contained model. For example, open source software development, wherein program source code is openly shared with unrelated developers and users, represents a collaborative development environment. Collaborative development may also occur in a semi-open or semi-controlled environment, such as between one or more contracting entities or communities. The amount of “openness” of a semi-open or semi-controlled collaborative development model may fall anywhere in between the more fully controlled self-contained development model and the less controlled open source development model.

Benefits of collaborative development models, such as with open source, are that developers can customize programs and share results within the programming community so that everyone learns from each other and community expertise is highly leveraged. On the other hand, because the collaborative development model distributes development control among multiple entities more so than in the conventional self-contained development model, intellectual property rights or licensing rights are not as easily identified, tracked and managed. For example, collaboratively developed products that are used and licensed into other collaboratively developed products, and/or into an end product, create a “linked” chain of products and licenses that make up or affect the end product. Because each product/license link is independently established under a collaborative model, the complete chain of licensing rights and/or restrictions is not centrally managed and, thus, may be difficult to identify and trace. In this context, problematically, each license in the chain may employ different and possibly conflicting rights and/or restrictions relative to each other license. Consequently, uncertainty may result in the end product with respect to applicable licenses, terms, rights and/or restrictions, and no central source or entity to clarify, identify or confirm the same.

Typically, developers will attempt to choose and use a software license that is either required or appropriate for the intended distribution of a new product. Numerous software licenses are currently available for collaborative or open source developed products. For example, the GNU General Public License (GPL), the Berkeley Software Distribution (BSD) license and the Mozilla Public License (MPL) are commonly used open source licenses. However, as software development efforts become more and more collaborative and the linked chain of products/licenses grows, it becomes increasingly more difficult to determine which software license may be appropriate or required for the end collaborative product. This is because, as mentioned, the end collaborative product may be composed, in part, of a number of separately and individually licensed software components, each potentially subject to a different licensing scheme and, thus, each mandating potentially differing or conflicting rights and/or restrictions.

### SUMMARY OF THE INVENTION

A computing system is configured to identify product attributes, including components, associated with a product and to resolve the attributes to determine licensing dependencies for the product. In another embodiment, the licensing dependencies are resolved with other product attributes to identify a potential license for the product.

### DESCRIPTION OF THE DRAWINGS

FIG. 1 is a block diagram depicting a schematic representation of one embodiment of the present invention.

FIG. 2 is a schematic block diagram depicting a computing system employing an embodiment of the present invention.

FIG. 3 is a schematic block diagram depicting an exemplary genealogy of a software product.

FIG. 4 is a table representation of a database of licenses and attributes of a product.

FIG. 5 is a table representation of a database of attribute definitions.

FIG. 6 is a flow chart depicting one embodiment of a method of the present invention.

FIG. 7 is a flow chart depicting an alternate method.

FIG. 8 is a block diagram depicting a representation of licensing dependencies as resolved with product attributes to determine a potential license for a product.

### DETAILED DESCRIPTION OF THE INVENTION

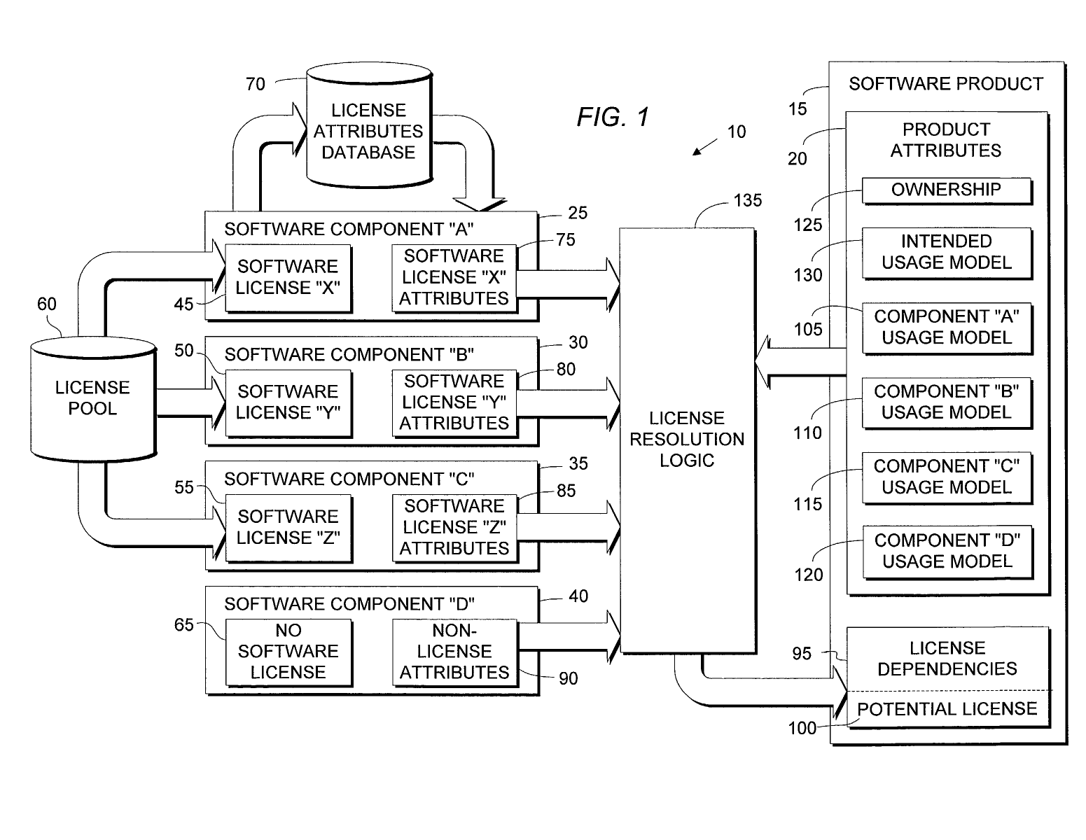

FIG. 1 is a high-level block diagram depicting, generally, an embodiment of a license resolution and generation system 10 according to the present invention. Each block represents a configuration of data, file(s), module(s), object(s), or other grouping or encapsulation of underlying functionality as implemented in programming code (either source, object, hex, binary or other machine level executable instructions) or retrievable data. However, the same underlying functionality or data may exist in one or more files, modules, objects, or other groupings or encapsulations that differ from those shown in FIG. 1 without departing from the present invention as defined by the appended claims.

It should also be noted here that the data, files, modules, objects or other groupings or encapsulations may exist, be stored, be retrieved, be executed or be transmitted within a configuration of a single computing system, among multiple systems, or across a distributed environment, such as a local area network, wide area network, intranet or even the Internet. Accordingly, for purposes of this disclosure, a “computing system” will be understood to include any one of or any combination of these configurations. The present invention is implemented with any such computing system configuration.

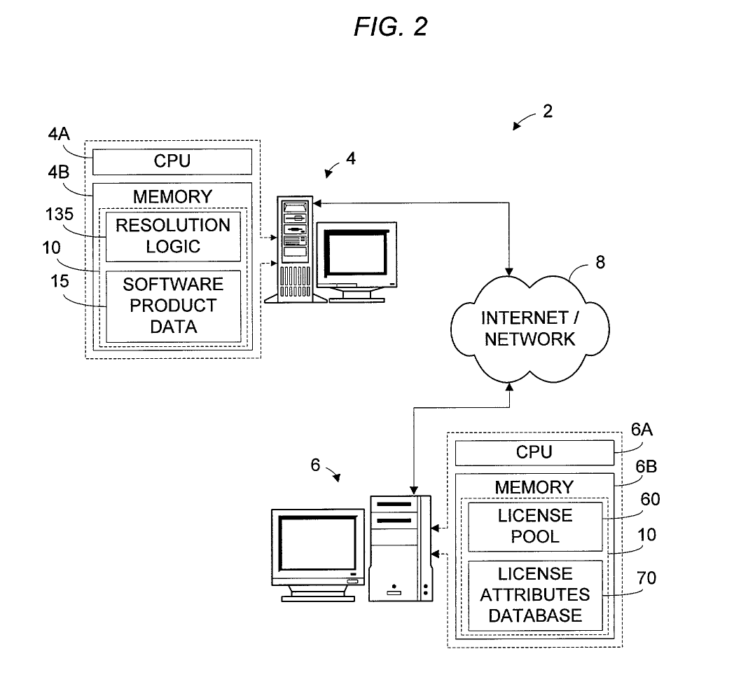

For example, FIG. 2 is a schematic block diagram depicting an exemplary computing system 2 employing an embodiment of the present invention. In the depicted computing system 2 a first exemplary computing device 4 employs a portion of an embodiment of the license resolution and generation system 10. Computing device 4 communicates over the Internet 8 with a second computing device 6 that employs another portion of the license resolution and generation system 10, all as will be discussed more fully subsequently herein. Clearly, the drawing is merely exemplary and is not intended to limit the numerous potential computing system configurations and variations of possible embodiments of the present invention in such computing system configurations.

Referring again to FIG. 1, the present invention will be described in the context of a software product 15 having product attributes 20 and employing certain software components 25, 30, 35, 40. However, it is understood that the invention is similarly applicable to any non-software product that may be subject to licensing issues as described and discussed herein. The software product 15 and software components 25, 30, 35, 40 comprise data, module(s), object(s), or other grouping or encapsulation of underlying functionality as implemented in programming code (either source, object, hex, binary or other machine level executable instructions) or usable data.

Each of the software components may be subject to a software license 45, 50, 55, derived from a license pool 60 that is representative of available software licenses known to the system 10. Although for simplicity of discussion and drawing purposes only one license is referenced respectively relative to each component in the drawing, it will be understood that a component may in fact be associated with more than one license. Additionally, a software component 40 may in fact not be subject to any conventional license found in the pool 60, or to any license at all 65. For example, the component 40 may be newly developed code that is owned by the entity developing the product 15. Thus, no license 65 is attached to that component 40 and the component exists as a non-licensed component, although other restrictions may be attached by the developing entity. Any component having no license will be referred to herein as a component having a non-license, or a non-licensed component.

Each of the licenses 45, 50, 55 and non-license 65 is referenced in a license attributes database 70. The database 70 includes translations of each license or non-license into a respective set of license attributes 75, 80, 85 or non-license attributes 90 as the case may be. For ease of discussion purposes, the license attributes and non-license attributes will be referenced herein jointly simply as license attributes, licensed attributes or licensing attributes. In essence, the license attributes 75, 80, 85 are a reduction of the legal language from each respective license 45, 50, 55 to a known attribute set that describes key elements, rights and/or restrictions defined by the respective license. Similarly, the non-license attributes 90 are a summary of any rights and/or requirements that may be associated with the non-licensed status 65 of the component 40. For example, it may be that the developer of the component 40 requires that the source code remain internal within the developer's own usage realm and not be distributed externally or publicly. As another example, non-licensed attributes may include a description identifying a level of proprietary, confidential, trade secret or patent importance of the software component relative to the owner of that component.

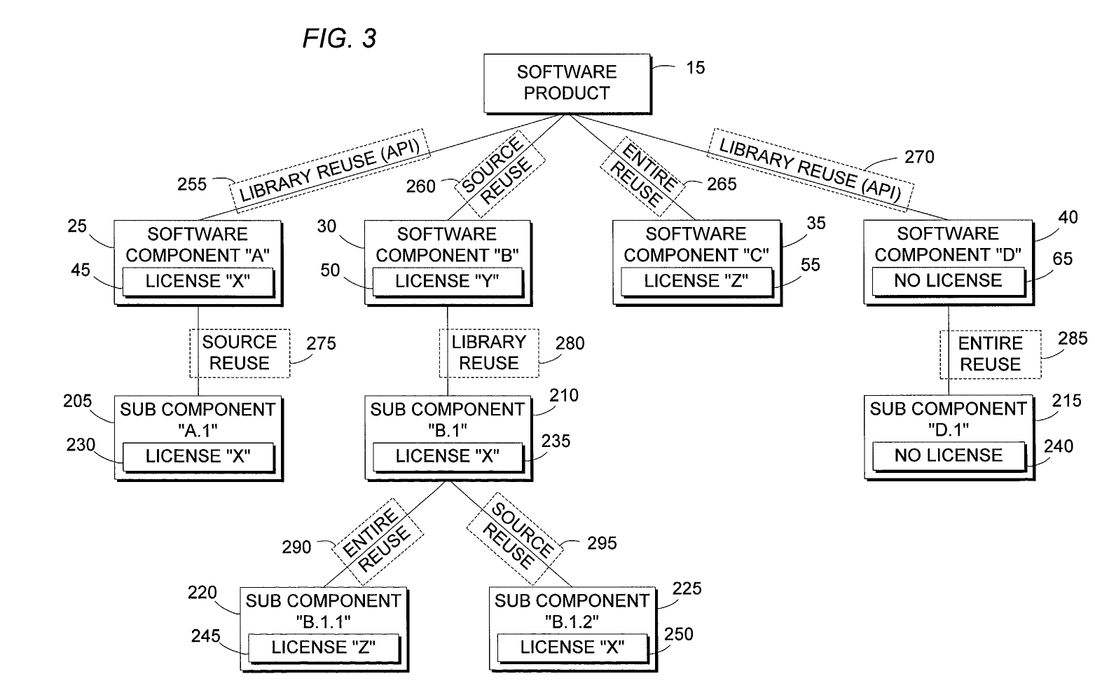

Broadly speaking, the product attributes 20 of the product 15 include, but are not limited to, those aspects of the product that are relevant to determining licensing dependencies 95 (i.e., license related aspects), and to generating potential licensing considerations, or in other words, a potential license 100 for the product. In this context, product attributes include certain elements associated with the genealogy of the product. For example, product attributes include identification of all components 25, 30, 35, 40 and sub-components (see FIG. 3) included, used or referenced in association with the product 15. For ease of discussion purposes throughout this disclosure, the term “component” may also include “sub-component” in appropriate context.

Product attributes also include indicia indicative of a usage (or reuse) model 105, 110, 115, 120 for each respective software component 25, 30, 35, 40 (and sub-component). Each usage model 105, 110, 115, 120 defines the relationship of the respective component 25, 30, 35, 40 to the product 15, including how the component is actually used in association with the product 15. For example, a component usage model defines whether source code of that component is reused (modified) within the product 15; whether only an object code (i.e., hex or binary) component such as a “.DLL” or other library file is reused (executed/accessed) by the product 15 via an interface such as an Application Programming Interface (API); whether the whole component is reused (executed) in its entirety as a complete program by the product 15; or whether the component is used in some other context or under some other conditions.

Although FIG. 1 only shows four exemplary component usage models 105, 110, 115, 120 for simplicity of drawing purposes, it is understood that the product attributes 20 include a usage model for any and all sub-components associated with the product (see FIG.2, discussed more fully subsequently herein). Namely, a complete components identification and usage model includes data that define the entire history (genealogy) of all component dependencies, including usage relationships among those dependencies, such that each complete linked chain of components (including sub-components), their relationships and usage models are identified.

Other product attributes 20 include ownership information 125, such as current owner identification and/or co-development ownership information for the product 15, and the intended usage model 130 of the product 15. The intended usage model 130 may include indicia such as prospective licensing considerations, intended ownership, whether intellectual property associated with the product will be kept proprietary, whether the product will be designated open source, or whether the product will be subject to rights defined by a semi-open collaborative effort with another party. This information is stored in a database, such as in separate fields or tables of the database 70, or some other feasible information storage medium and configuration in a computing system.

The license resolution and generation system 10 also includes license resolution control logic 135 in communication with the product attributes 20. In one embodiment, the license resolution logic 135 is configured to identify and resolve the genealogy of the product 15 or, in other words, the licensing dependencies 95 of the product 15 without further analysis of how those dependencies actually affect the product 15. This includes identifying and resolving all components 25, 30, 35, 40 (and sub-components), licenses 45, 50, 55 (and non-licenses 65), license attributes 75, 80, 85 (and non-license attributes 90) rights and/or restrictions and, optionally, usage models 105, 110, 115, 120. But no analysis is performed with respect to the effect those components, licenses and attributes actually have on the product 15. In another embodiment, the resolution logic 135 is configured to resolve the licensing dependencies 95 with other relevant product attributes 20, 125, 130 to identify or suggest one or more proper, potential licenses 100 for the product 15. For purposes of this disclosure, resolving includes enabling the assembling, gathering, comparing and/or presenting of data in logical or coherent relationships.

Although in a preferred embodiment the control logic of the present invention is embodied in software as discussed above, as an alternative the logic may also be embodied in firmware, hardware, or a combination of software, firmware and/or hardware. If embodied in hardware, the logic can be implemented as a circuit, a number of interconnected circuits, or a state machine that employs any one of or a combination of a number of technologies to implement the specified logical function(s) and/or data. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

Additionally, the logic can be embodied in any computer-readable medium for use by or in connection with an instruction execution system such as a computer/processor 4A, 6A based system 4, 6 or other system that can fetch, obtain or receive the logic from the computer-readable medium and execute the instructions and/or process the data contained or carried therein. In the context of this document, a computer-readable medium is any tangible or intangible medium, or combination thereof, that can contain, store, enable the transfer of, or maintain the logic for use by or in connection with the instruction execution system. Intangible medium includes any carrier medium such as a carrier wave or carrier signal capable of being modulated by a second, data-carrying signal.

The computer-readable medium can comprise any one of many physical media such as, for example, electronic, magnetic, optical, electromagnetic, infrared, radio frequency or semiconductor media, in either a hardwired or wireless form as the case may be. Specific examples of a suitable computer-readable medium include, but are not limited to, a portable magnetic computer diskette such as a floppy diskette or hard drive, a random access memory (RAM) 4B, 6B, a read-only memory (ROM), an erasable programmable read-only memory, a portable compact disc, and a carrier signal such as is employed in a wired or wireless network communication scheme, whether it be in a local area network, wide area network, intranet network, Internet network, or a point to point communication connection.

Referring now to FIG. 3, a schematic block diagram depicts a fully resolved exemplary genealogy of the software product 15, and is representative of a snapshot picture of license dependencies 95 identified and/or reported by the license resolution logic 135. This tree-structure view is provided to enhance the understanding of items, issues and relationships associated with the product 15 in the context of license dependencies 95. In one embodiment, the data represented in FIG. 3 is reported simply as the license dependencies 95 of the product 15 without any further analysis of how the dependencies actually affect the product 15 for potential future licensing purposes of the product. In another embodiment, the data represented in FIG. 3 is further analyzed and leveraged to identify and/or generate a potential license 100 for the product 15.

The dependencies depicted in FIG. 3 include identification of software components (including sub-components) used by the product 15, component and sub-component reuse models, and component and sub-component licenses. Again, each block represents a configuration of data, file(s), module(s), object(s), or other grouping or encapsulation of underlying functionality as implemented in programming code (either source, binary or machine level executable instructions) or retrievable data. However, the same underlying functionality or data may exist in one or more files, modules, objects, or other groupings or encapsulations that differ from those shown in FIG. 3 without departing from the spirit and scope of the present invention. Each line that links one block to another represents a relationship link that identifies a usage (reuse) model between the linked components.

It is understood that any given product will have its own unique genealogy. As such, the depiction in FIG. 3 is merely exemplary for the product 15. The stored availability of that unique genealogy enables the present invention, including the license resolution logic 135 (see FIG. 1), to determine the license dependencies 95. The stored availability of the genealogy, in combination with the stored availability of other product attributes 20, 125, 130, enable the license resolution logic 135 to generate potential licensing considerations and/or a potential license 100 for the given product 15.

FIG. 3 clearly identifies each component and the relationships of each of the software components 25, 30, 35, 40 and sub-components 205, 210, 215, 220, 225 to each other and to the product 15. Additionally, each license (and non-license) is identified 45, 50, 55, 65, 230, 235, 240, 245, 250, and each usage (reuse) model is identified 255, 260, 265, 270, 275, 280, 285, 290, 295, with respect to each component and sub-component. All licenses referenced in FIGS. 1 and 2 are merely representative of exemplary software licenses, such as conventional, custom or open source licenses. Although not depicted here (to simplify the drawing), respective license attributes 75, 80, 85, 90 may also be identified for each license. Notably, all of this genealogy is captured under the broad notion of product attributes 20 for the software product 15 because each item may affect the determination of an appropriate, potential license 100 for the product 15. The license resolution logic 135 (FIG. 1) resolves this stored data to determine this complete picture of license dependencies 95 and to determine or generate a potential license 100 for the product 15.

To further detail and understand FIG. 3, especially in view of the components, licenses and relationships that must be considered by the resolution logic 135, we first note that component “A” 25 is subject to license “X” 45. The product 15 uses the library 255 of component “A” 25 through a conventional application programming interface (API) provided by component “A” 25. Thus, the usage (reuse) model of component “A” 25 relative to the product 15 is a library reuse model 255 and carries with it the rights and restrictions associated with the license “X” 45 under that library reuse model, in cooperation with any further sub-component 205 licensing dependencies 275, 230.

Sub-component “A.1” 205 is also subject to license “X” 230. Component “A” uses a source-modified version 275 of the code of sub-component “A.1” 205. Thus, the usage model of sub-component “A.1” 205 relative to the component “A” 25 is a source reuse model 275 and carries with it the rights and restrictions associated with the license “X” 230 under that source reuse model.

Component “B” 30 is subject to license “Y” 50. The product 15 uses a source-modified version 260 of the code of component “B” 30. Thus, the usage model of component “B” 30 relative to the product 15 is a source reuse model 260 and carries with it the rights and restrictions associated with the license “Y” 50 under that source reuse model, in cooperation with any further sub-component 210, 220, 225 licensing dependencies 280, 235, 290, 245, 295, 250.

Sub-component “B.1” 210 is subject to license “X” 235. Component “B” uses the library 280 of sub-component “B.1” 210 through a conventional application programming interface (API) provided by sub-component “B.1” 210. Thus, the usage model of component “B.1” 210 relative to the component “B” 30 is a library reuse model 280 and carries with it the rights and restrictions associated with the license “X” 235 under that library reuse model, in cooperation with any further sub-component 220 , 225 licensing dependencies 290, 245, 295, 250.

Sub-component “B.1.1” 220 is subject to license “Z” 245. Sub-component “B.1” 21 0 uses the entire code 290 of sub-component “B.1.1” 220 without modification. Thus, the usage model of component “B.1.1” 220 relative to the component “B.1” 210 is an entire reuse model 290 and carries with it the rights and restrictions associated with the license “Z” 245 under that entire reuse model.

Sub-component “B.1.2” 225 is subject to license “X” 250. Sub-component “B.1” 210 uses a source-modified version 295 of the code of sub-component “B.1.2” 225. Thus, the usage model of component “B.1.2” 225 relative to the sub-component “B.1” 210 is a source reuse model 295 and carries with it the rights and restrictions associated with the license “X” 250 under that source reuse model.

Component “C” 35 is subject to license “Z” 55. The product 15 uses the entire code 265 of component “C” 35 without modification. Thus, the usage model of component “C” 35 relative to the product 15 is an entire reuse model 265 and carries with it the rights and restrictions associated with the license “Z” 55 under that entire reuse model.

Component “D” 40 is not subject to any license 65. In this example, component “D” 40 is subject to no license 65 because the component was originally developed by the same entity developing the product 15. The product 15 uses the library 270 of component “D” 40 through a conventional application programming interface (API) provided by component “D” 40. Thus, the usage model of component “D” 40 relative to the product 15 is a library reuse model 270 and carries with it only the arbitrary rights and restrictions designated by the same developing entity of the product, in cooperation with any further sub-component 215 licensing dependencies 285, 240.

Sub-component “D.1” is also not subject to any license 240. Component “D” 40 uses the entire code 285 of sub-component “D.1” 215 without modification. Thus, the usage model of sub-component “D.1” 215 relative to the component “D” 40 is an entire reuse model 285 and carries with it only the arbitrary rights and restrictions designated by the same developing entity.

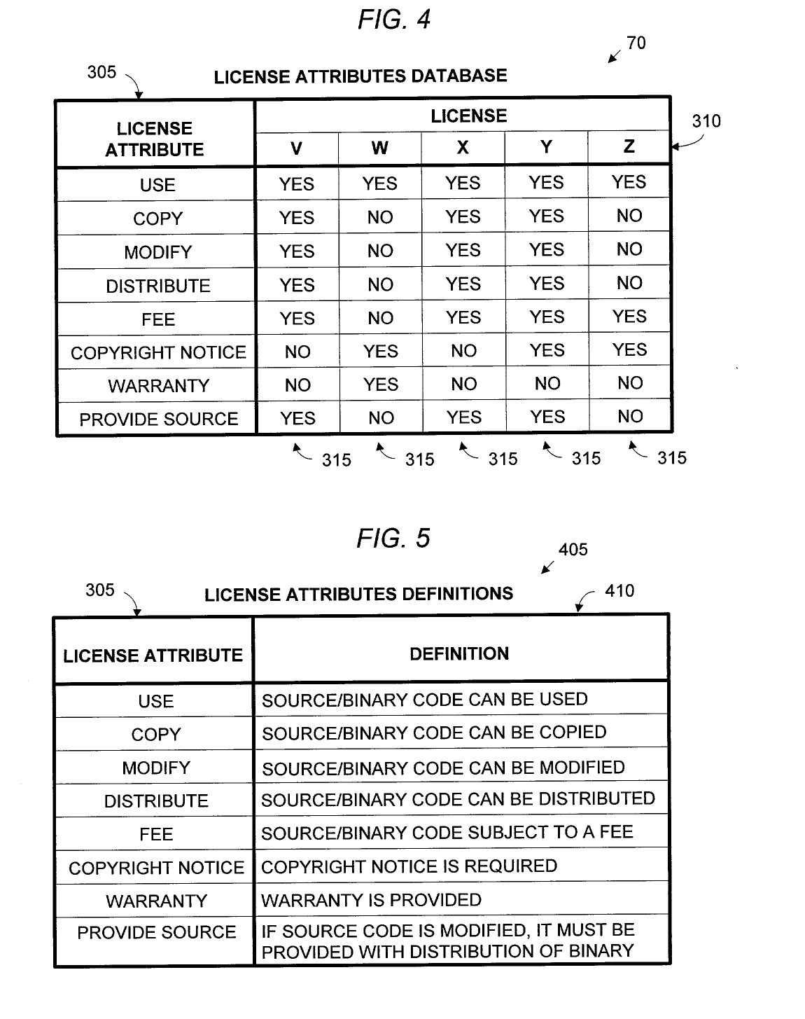

Referring now to FIG. 4, an exemplary representation of a portion of the database 70 is shown in table format having an arbitrary set of license attributes 305, 315 with respect to arbitrary licenses “V”, “W”, “X”, “Y” and “Z” 310. It is understood that FIG. 4 is merely exemplary and does not represent the entire database or a complete set of attributes or licenses that may be referenced, and does not represent that the attributes associated with any exemplary license are necessarily representative of any actual conventional license. Additionally, although the table layout is representative of one embodiment of a simple database format, it is understood that any conventional database configuration is feasible, such as a relational or flat file database.

The database 70 maintains a set of key license attributes 305, 315 that are known with respect to each license referenced 310. In the depicted example, the relevance of each license attribute is shown in a binary-type of “yes” and “no” format 315. For example, with respect to license “X”, its license attributes 305, 315 provide rights and restrictions including the right to “use” the code, “copy” the code, “modify” and “distribute” the code. It also provides the right that the code can be subject to a “fee” and that no “copyright notice” is required. License “X” also provides for certain restrictions, such as that there is no “warranty,” and that the “source” code must be provided or made available with any distribution of a binary version of the code. It should be noted here that although not depicted in the table of FIG. 4, the database 70 may also include key attributes relative to any non-license 65.

Exemplary definitions for the license attributes 305 identified in FIG. 4 are set forth in the table represented database 405 of FIG. 5. These definitions 410 are optionally stored in the system 10, such as in further tables or fields of the database 70, to provide a more complete understanding of the license attributes 305 for entry and/or reporting purposes.

It should be noted here that although the depicted table format of the license attributes database 70 in FIG. 4 appears to represent each identified license 310 as having static attributes 315, it is to be understood that each license may in fact employ attributes of a dynamic nature. Dynamic attributes exist where language and terms in the license form conditional logic. Such conditional logic is carefully translated into the attributes database 70 and the definitions database 405 to retain the dynamic aspects of the license. For example, as is well known with respect to the conventional GPL, that license requires that source code be made available only if the source is modified and if the resulting object (binary) code of the modified source is distributed. To this regard, FIG. 4 and FIG. 5 together demonstrate one example of conditional logic in the “Provide Source” attribute 305. Specifically, with respect to license “V” for example, the “Provide Source” attribute 315 in the attributes database 70 is marked as “Yes.” But to clarify the conditional logic, the definition 410 for the “Provide Source” attribute 305 in the definitions database 405 explains that the source code must be made available only if the source is modified and the resulting object (binary) code of the modified source is actually distributed.

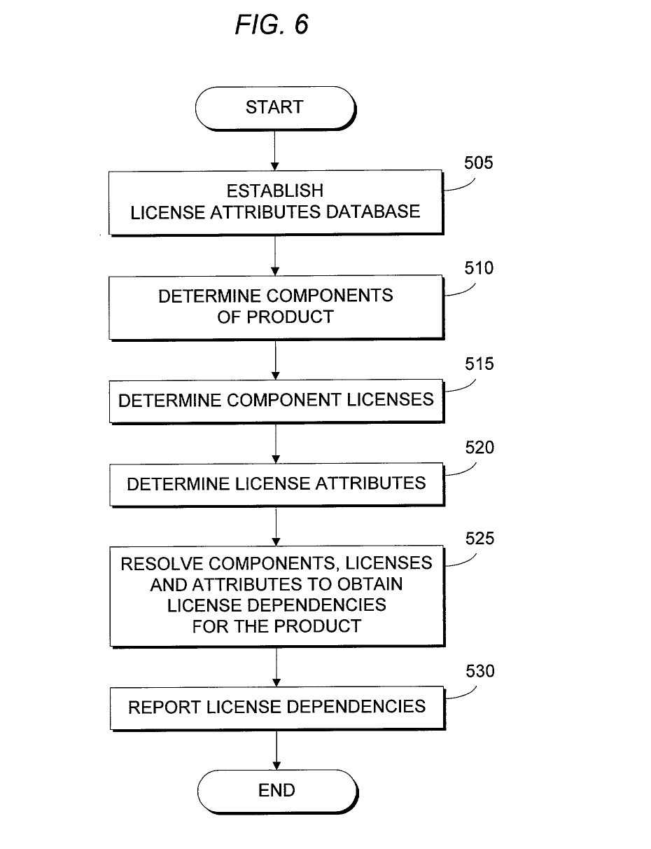

Referring now to FIG. 6, a flow chart depicts one embodiment of a method of the present invention. First, 505, a license attributes database 70 is established. This database includes specific, key attributes 305, 315 for each license 310 (or non-license) known to the database. In essence, the database is a reduction of the legal language in a license, or aspects of a non-license, to a known attribute set 305, 315 that describe key elements, rights and/or restrictions of the license or non-license.

Next 510, all of the components 25, 30, 35, 40 (including sub-components 205, 210, 215, 220, 225) are identified that are included in the genealogy of the product 15 being developed. Additionally, 515, all licenses 45, 50, 55, 230, 235, 245, 250 associated with all components are identified (including whether or not no license 65, 240 is associated with any given component). Subsequently, 520, all license attributes are identified for those licenses and non-licenses associated with the components of the product. The identification of license attributes for any given component can be as simple as merely referencing attributes fields 310, 315 embodied in the license attributes database 70. Each of these steps 510, 515, 520 is facilitated by having previously stored the respective information in a database, such as in further tables or fields of the database 70, or in some other area or database of a computing system.

Now, 525, all of these license-related elements associated with the product 15 are resolved together, including identification of all components, component licenses, and license attributes. Optionally, component license reuse models are also included. The resolved licensing dependencies reflect a summary of licensing issues relative to the product 15.

Finally, the licensing dependencies for the product 15 are then reported 530. The dependencies are reported as a resolved summary in a usable format. The report may be stored electronically for later retrieval, or output visibly to a video device or hardcopy device. For example, in one embodiment the visual output report is in the format of a genealogical chart as depicted in FIG. 3. Alternatively, the output may be in a table format, similar to the table referenced in FIG. 4, or in any other visual reporting format that clearly identifies the license dependencies discovered. The report serves as a resource to clearly notify a developer that there are licensing issues associated with the product 15 that may need to be more fully considered with respect to further licensing the resulting end product 15.

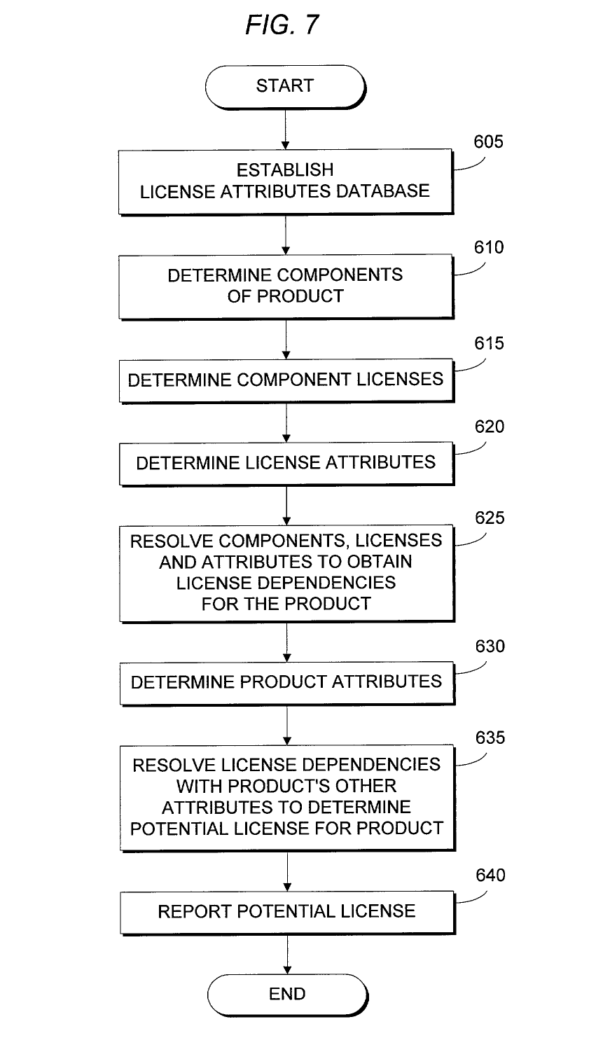

Referring now to FIG. 7, a flow chart depicts an alternate method of the present invention. In this embodiment, steps 605, 610, 615, 620 and 625 correspond to steps 505, 510, 515, 520 and 525 of FIG. 6. Accordingly, the discussion in FIG. 6 with respect to those steps is incorporated here and will not be reiterated. However, in this embodiment, after the licensing dependencies are determined 625 for the product 15, the next step 630 is to determine what are any other relevant product attributes 20 for the product 15. Other product attributes 20 include ownership information 125 of the product, intended usage model 130 for the product, usage models 105, 110, 115, 120 for components of the product (if not already resolved), and any other attributes that affect determination of a proper potential license 100 for the product 15.

Next, 635, the other relevant product attributes are resolved with the licensing dependencies 95 to determine a potential license 100 for the product 15. This includes reference associating each component usage model 105, 255, 275, 110, 260, 280, 290, 295, 115, 265, 120, 270, 285 with the licensing rights and/or restrictions that are associated with each component 25, 30, 35, 40, 205, 210, 215, 220, 225 and its respective license. For example, with respect to component “A” 25, it is subject to license “X” 45 which carries those dependencies identified in the license attributes database 70 and depicted in Table 1. Component “A” 25 includes sub-component “A.1” 205 which is also subject to license “X” 230. Component “A” 25 is utilized in the product 15 under a library reuse model 255. Sub-component “A.1” 205 is utilized in component “A” under a source reuse model 275. These elements are resolved together to determine the rights and restrictions to which the product 15 is subject.

Specifically, in this example, based on component “A” 25 and sub-component “A.1” 205 and their respective licenses “X” 45, 230, these elements are resolved to understand that the product 15 can be used, copied modified and distributed, can be subject to a fee, does not require a copyright notice, does not carry a warranty (with respect to the respective component 25 and sub-component 205), and source code must be provided with any distribution of binary code. In view of these aspects, the fact that the product 15 uses component “A” 25 under a library reuse model 255 has no consequential effect here. Regardless, all of these elements are further evaluated in view of the other product attributes such as current ownership information 125 and intended usage model of the product 15. For example, in this context, if the current ownership 125 is a single entity, and the intended usage model is for privately licensed use and distribution only (non-open source), then the resolving step considers those factors. In this example, further use and distribution would be a problem and the developer would need to reconsider the options. This process of resolving license dependencies with product attributes is repeated until all product attributes have been analyzed with respect to all components, sub-components, licenses and usage models.

Finally, these dependencies and attributes for the product 15 are then reported 640. The dependencies and attributes are reported as a resolved summary or, optionally, as an itemized list of licensing rights and/or restrictions or as a full, potential license 100 that best fits within the parameters defined by the resolved dependencies and attributes. Essentially, the resolving requires an element by element comparison of the licensed dependencies and the other product attributes. Depending on the resolving, the potential license may be one that is already referenced 615 with the product 15, or it may be one found in the database 70 or license pool 60 but not associated with any particular component of the product 15. Again, the report 100, 640 may be output in any conventional format, and either stored electronically for later retrieval, or output visibly to a video device or hardcopy device.

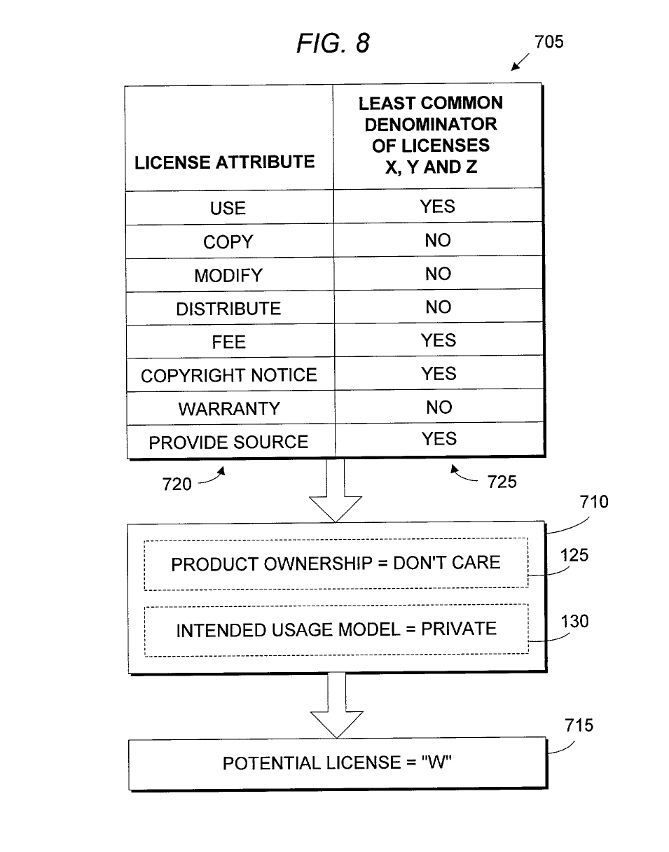

FIG. 8 is a block diagram depicting a representation of resolved licensing dependencies 705 that are further resolved with product attributes 710, 125, 130 to enable the proposal of a potential license 715, 100. The table 705 depicts a representation of the attributes 720, 75, 80, 85 of each of the licenses “X” 45, “Y” 50 and “Z” 55 after having been resolved 725, 525, 625 with respect to each other. Each of the licenses “X”, “Y” and “Z” is found in the genealogy of the exemplary product 15. In essence, the table 705 depicts the least common denominator 725 for each attribute 720, 305, 315 as between the licenses “X”, “Y” and “Z”. In other words, the table 705 depicts the result after each of the attributes for each license “X”, “Y” and “Z” is referenced with each respective attribute for each other license in the genealogy of the product 15 to determine the least common denominator for each attribute. Notably, the least common denominator for any attribute generally represents the controlling aspect for that attribute relative to the product 15. Notably, the table 705 summarizes the licensing rights and restrictions that accompany the product 15.

FIG. 8 also depicts that the least common denominator attribute information 705 is resolved 635 with other attributes 710 of the product 15, such as the ownership information 125 and intended usage model 130. These dependencies 705 and attributes 710 are considered and resolved relative to each other to identify or generate a potential license “W” 715, 100 for the product. In this context, license “W” most closely matches all of the combined rights and/or restrictions that are referenced in the components of the product 15.

Finally, while the present invention has been described by reference to specific embodiments, it will be apparent that other alternative embodiments and methods of implementation or modification may be employed without departing from the true spirit and scope of the invention.

what is claimed is:

1. A method, comprising:
(a) identifying in a computing system product attributes associated with a product; and,
(b) resolving a first subset of the product attributes to determine licensing dependencies for the product.

2. The method of claim 1 further including, prior to identifying, storing the product attributes in the computing system.

3. The method of claim 1 wherein identifying the product attributes includes identifying components of the product and licenses associated with the components.

4. The method of claim 3 wherein identifying the product attributes further includes identifying usage models associated with the components.

5. The method of claim 3 wherein identifying the product attributes further includes identifying license attributes of the licenses.

6. The method of claim 1 further including resolving the licensing dependencies with a second subset of the product attributes to identify a potential license for the product.

7. A method, comprising:
(a) identifying in a computing system licensing attributes associated with one or more components of a product; and,
(b) resolving the licensing attributes to determine licensing aspects related to the product.

8. The method of claim 7 further including resolving the licensing attributes with product attributes of the product to identify potential licensing considerations for the product.

9. A computer-readable medium having computer-executable instructions configured to: (a) identify licensing attributes associated with one or more components of a product, and (b) resolve the licensing attributes to determine licensing dependencies for the product.

10. A computer-readable medium having computer-executable instructions configured to: (a) identify licensing dependencies associated with one or more components of a product, and (b) generate potential licensing considerations for the product.

11. A data signal embodied in a carrier medium and configured to: (a) identify licensing attributes associated with one or more components of a product, and (b) resolve the licensing attributes to determine licensing dependencies for the product.

12. A data signal embodied in a carrier medium and configured to: (a) identify licensing dependencies associated with one or more components of a product, and (b) generate potential licensing considerations for the product.

13. A computing system comprising:
(a) component data indicative of components associated with a product;
(b) license data indicative of licenses associated with the components; and
(c) control logic configured to resolve the component data with the license data to determine licensing dependencies for the product.

14. The system of claim 13 wherein the component data includes component use data indicative of use associations between the components.

15. The system of claim 13 wherein the license data includes license attributes data that define key elements of the licenses.

16. The system of claim 13 further including product attribute data indicative of attributes associated with the product, and wherein the control logic is further configured to resolve the licensing dependencies with the product attribute data to identify a potential license for the product.

17. A license generation system, comprising:
(a) license dependency data associated with one or more components of a product;
(b) product attribute data associated with the product; and
(c) control logic configured to resolve the license dependency data with the product attribute data to generate potential licensing considerations for the product.

18. The system of claim 17 wherein the license dependency data includes licensing elements identified with licenses associated with the one or more components.

19. A computing system comprising:
(a) a processor configured to execute instructions;
(b) at least one memory device coupled to the processor;
(c) component data stored in the at least one memory device and indicative of components associated with a product;
(d) license data stored in the at least one memory device and indicative of licenses associated with the components; and
(e) control logic stored in the at least one memory device and configured to resolve the component data with the license data to determine licensing dependencies for the product.

20. The system of claim 19 further including product attribute data stored in the at least one memory device and indicative of attributes associated with the product, and wherein the control logic is further configured to resolve the licensing dependencies with the product attribute data to identify a potential license for the product.
